(19) United States
(12) Patent Application Publication
(10) Pub. No.: US 2021/0072759 A1
(43) Pub. Date: Mar. 11, 2021

(54) ROBOT AND ROBOT CONTROL METHOD

(71) Applicant: LG ELECTRONICS INC., Seoul (KR)

(72) Inventors: Seungmin BAEK, Seoul (KR); Jeongwoo JU, Seoul (KR)

(21) Appl. No.: 16/890,007

(22) Filed: Jun. 2, 2020

(30) Foreign Application Priority Data
Sep. 6, 2019 (KR) 10-2019-0110665

(51) Int. Cl. G05D 1/02; B25J 9/16

(52) U.S. Cl. CPC G05D 1/0219; G05D 1/0214; B25J 9/161; B25J 9/1661; B25J 9/1664; B25J 9/162

(57) ABSTRACT

A robot control method and a robot are disclosed. The robot control method and the robot configured to perform the method may communicate with other electronic devices and a server in a 5G communication environment, and determine an operator to assist in performance of a subtask according to a difficulty level of the subtask.

### CROSS-REFERENCE TO RELATED APPLICATION

Pursuant to 35 U.S.C. § 119(a), this application claims the benefit of an earlier filing date of and right of priority to Korean Patent Application No. 10-2019-0110665, entitled “ROBOT AND ROBOT CONTROL METHOD,” filed on Sep. 6, 2019, and the entire disclosure of which is incorporated herein by reference. This work was supported by the ICT R&D program of MSIT/IITP[2017-0-00306, Development of Multimodal Sensor-based Intelligent Systems for Outdoor Surveillance Robots].

### BACKGROUND

### 1. Technical Field

The present disclosure relates to a robot control method and a robot, and more particularly, to a method for controlling semi-autonomous driving of a robot and a robot that performs the method.

### 2. Description of Related Art

A robot generally has two operation modes. One is an autonomous driving mode, and the other is a remote control mode.

In the remote control mode, the robot moves according to a user's operation of a control center. The robot transmits an image signal captured by a camera to the control center, the control center displays the received image, and the user operates an operation apparatus while watching the received image.

Korean Patent Application Publication KR 10-2013-0045291 A discloses an autonomous mobile robot and a driving control method, which move a mobile robot to a safe position by using an emergency adjustment means when the mobile robot is in an emergency situation or when there occurs a situation in which the mobile robot does not enter an evacuation space or a waiting area during driving.

Korean Patent Application Publication No. KR 10-2016-0020278 A discloses a method for allocating an operation mode of a remote control based unmanned robot that changes the operation mode when an emergency condition is sensed in a driving state.

However, there is inconvenience that the operator should directly approach the robot to operate the emergency adjustment means (for example, the joystick) of the robot or to execute necessary measures if there occurs a situation in which the driving of the above-described robot becomes difficult.

### SUMMARY OF THE DISCLOSURE

An aspect of the present disclosure is to address a shortcoming associated with some related art in which an operator should directly approach a robot to execute necessary measures if there occurs a situation in which driving of the robot becomes difficult.

Another aspect of the present disclosure is to provide a robot capable of completing a given task through semi-autonomous driving even when autonomous driving becomes difficult.

Still another aspect of the present disclosure is to provide a robot control method capable of remotely controlling a robot by an unspecified number of users.

Aspects of the present disclosure are not limited to the above-mentioned aspects, and other technical aspects not mentioned above will be clearly understood by those skilled in the art from the following description.

A robot control method according to an embodiment of the present disclosure, includes receiving task information on a task of driving to a destination, generating a plurality of subtasks according to a plurality of route sections included in route information from a current position to the destination, determining a difficulty level of a subtask of the plurality of subtasks, and determining an operator to assist in performance of the subtask according to the difficulty level of the subtask.

In detail, the determining the operator may include recruiting applicants for the subtask and selecting the operator from among the applicants based on reliability the applicants.

To this end, the determining a difficulty level may include determining a congestion level of the route section corresponding to the subtask, determining a driving difficulty level of the subtask based on the congestion level, and determining the difficulty level based on the driving difficulty level.

Here, the determining a congestion level may include determining the congestion level of the route section by using a learning model based on an artificial neural network.

A robot according to another embodiment of the present disclosure includes a memory configured to store map data and a processor configured to generate route information of a task of driving to a destination based on the map data. The processor may be configured to perform an operation of generating a plurality of subtasks according to a plurality of route sections included in the route information, an operation of determining a difficulty level of a subtask of the plurality of subtasks, and an operation of determining an operator to assist in performance of the subtask according to the difficulty level of the subtask.

Here, the operation of determining the operator may include an operation of recruiting applicants for the subtask and an operation of selecting the operator from among the applicants based on reliability of the applicants.

The processor may be further configured to determine the operator's reliability based on a subtask performance result of the operator.

Other embodiments, aspects, and features in addition those described above will become clear from the accompanying drawings, the claims, and the detailed description of the present disclosure.

According to the present disclosure, it is possible to select an operator to control semi-autonomous driving of a robot so as to complete the given task if autonomous driving becomes difficult.

Further, according to the present disclosure, it is possible to perform remote control of the robot by an unspecified number of the users even without a separate central control center, and to improve the driving capability.

The effects of the present disclosure are not limited to those mentioned above, and other effects not mentioned may be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of a robot control environment according to an embodiment of the present disclosure;

FIG. 2 is a block diagram of a robot according to an embodiment of the present disclosure;

FIG. 3 is a flowchart of a robot control method according to an embodiment of the present disclosure;

FIG. 4 is a table illustrating subtask information for performing an exemplary task;

FIG. 5 is a flowchart of a robot control method according to an embodiment of the present disclosure;

FIG. 6 is a table illustrating exemplary applicant information;

FIG. 7 is a flowchart of an operator determination process according to an embodiment of the present disclosure;

FIG. 8 is a flowchart of a reliability determination process according to an embodiment of the present disclosure;

FIG. 9 is a block diagram of a server according to an embodiment of the present disclosure.

### DETAILED DESCRIPTION

Hereinafter, an embodiment disclosed herein will be described in detail with reference to the accompanying drawings, and the same reference numerals are given to the same or similar components and duplicate descriptions thereof will be omitted. Also, in describing an embodiment disclosed in the present document, if it is determined that a detailed description of a related art incorporated herein unnecessarily obscure the gist of the embodiment, the detailed description thereof will be omitted.

The terminology used herein is used for the purpose of describing particular exemplary embodiments only and is not intended to be limiting. As used herein, the articles “a,” “an,” and “the,” include plural referents unless the context clearly dictates otherwise. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof. Furthermore, terms such as “first,” “second,” and other numerical terms may be used herein only to describe various elements, but these elements should not be limited by these terms. These terms are only used to distinguish one element from another.

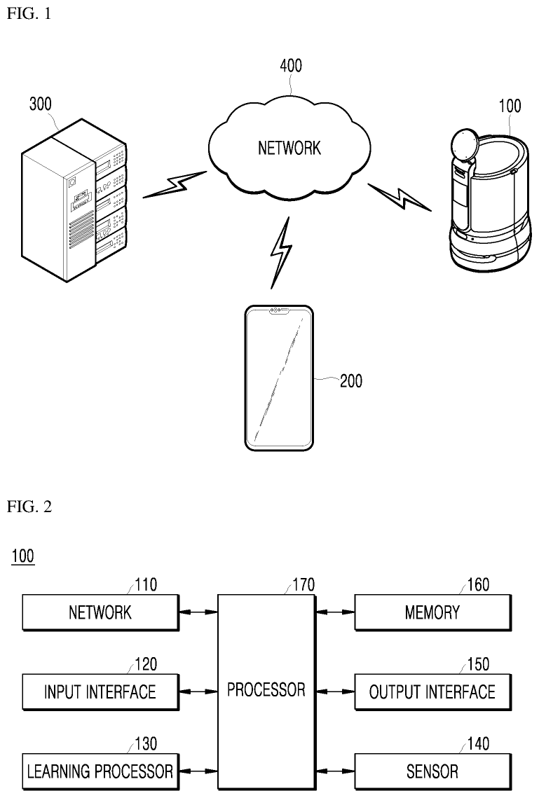

FIG. 1 is an exemplary diagram of a robot control environment according to an embodiment of the present disclosure.

A robot control environment may include a robot 100, a terminal 200, a server 300, and a network 400 configured to connect the above components.

Referring to FIG. 1, the robot control environment may include the robot 100, the terminal 200, the server 300, and the network 400. In addition to the devices illustrated in FIG. 1, various electronic devices may be connected to each other through the network 400 and operated.

The robot 100 may refer to a machine which automatically handles a given task by its own ability, or which operates autonomously. In particular, a robot having a function of recognizing an environment and performing an operation according to its own determination may be referred to as an intelligent robot.

The robot 100 may be classified into industrial, medical, household, and military robots, according to the purpose or field of use.

The robot 100 may include an actuator or a driver including a motor in order to perform various physical operations, such as moving joints of the robot. Moreover, a movable robot may include, for example, a wheel, a brake, and a propeller in the driver thereof, and through the driver may thus be capable of traveling on the ground or flying in the air.

By employing AI technology, the robot 100 may be implemented as a guide robot, a transport robot, a cleaning robot, a wearable robot, an entertainment robot, a pet robot, or an unmanned flying robot.

The robot 100 may include a robot control module for controlling its motion. The robot control module may correspond to a software module or a chip that implements the software module in the form of a hardware device.

Using sensor information obtained from various types of sensors, the robot 100 may obtain status information of the robot 100, detect (recognize) the surrounding environment and objects, generate map data, determine a movement route and drive plan, determine a response to a user interaction, or determine an operation.

Here, in order to determine the movement route and drive plan, the robot 100 may use sensor information obtained from at least one sensor among lidar, radar, and a camera.

The robot 100 may perform the operations above by using a learning model configured by at least one artificial neural network. For example, the robot 100 may recognize the surrounding environment and objects by using the learning model, and determine its operation by using the recognized surrounding environment information or object information. Here, the learning model may be trained by the robot 100 itself or trained by an external device such as the server 300.

At this time, the robot 100 may perform the operation by generating a result by employing the learning model directly, but may also perform the operation by transmitting sensor information to an external device such as the server 300 and receiving a result generated accordingly.

The robot 100 may determine the movement route and drive plan by using at least one of object information detected from the map data and sensor information or object information obtained from an external device, and drive according to the determined movement route and drive plan by controlling its locomotion platform.

The map data may include object identification information about various objects disposed in the space in which the robot 11 drives. For example, the map data may include object identification information about static objects such as walls and doors and movable objects such as flowerpots and desks. In addition, the object identification information may include a name, a type, a distance to, and a location of the objects.

In addition, the robot 11 may perform the operation or drive by controlling its locomotion platform based on the control/interaction of the user. At this time, the robot 11 may obtain intention information of the interaction according to the user's motion or spoken utterance, and perform an operation by determining a response based on the obtained intention information.

Artificial intelligence refers to a field of studying artificial intelligence or a methodology for creating the same. Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The ANN may include an input layer, an output layer, and may selectively include one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an ANN is to determine a model parameter for significantly reducing a loss function. The loss function may be used as an indicator for determining an optimal model parameter in a learning process of an artificial neural network.

The machine learning may be classified into supervised learning, unsupervised learning, and reinforcement learning depending on the learning method.

Supervised learning may refer to a method for training an artificial neural network with training data that has been given a label. In addition, the label may refer to a target answer (or a result value) to be guessed by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

The terminal 200 is an electronic device operated by a user or an operator, and the user may use the terminal 200 to drive an application for controlling the robot 100 or access an application installed in an external device including the server 300. The user may receive and respond to an assistance request (for example, a remote control request) of the robot 100 or the server 300 by using the application installed in the terminal 200. The terminal 200 may provide a remote control function of the robot 100 to the user through the application.

The terminal 200 may receive information such as state information of the robot 100 from the robot 100 and/or the server 300 through the network 400. The terminal 200 may provide the user with a function of controlling, managing, and monitoring the robot 100 through the mounted application.

The terminal 200 may include a communication terminal capable of performing functions of a computing device (not illustrated), and may include, but is not limited to, a user-operable desktop computer, a smartphone, a notebook computer, a tablet PC, a smart TV, a mobile phone, a personal digital assistant (PDA), a laptop computer, a media player, a micro server, a global positioning system (GPS) device, an E-book reader, a digital broadcasting terminal, a navigation system, a kiosk information system, an MP3 player, a digital camera, a home appliance, and any other mobile or immobile computing devices. Further, the terminal 200 may be a wearable device such as a clock, eyeglasses, a hair band, and a ring having a communication function and a data processing function. However, the terminal 200 is not limited thereto, and all kinds of terminals capable of web-browsing may also be applied to the present disclosure.

The server 300 may include a web server or an application server configured to control the robot 100 and to control the robot 100 remotely by using the application or the web browser installed in the terminal 200. The server 300 may be a database server that provides big data necessary for applying various artificial intelligence algorithms and data relating to a robot control.

The network 400 may serve to connect the robot 100, the terminal 200, and the server 300. The network 400 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 400 may send and receive information by using the short distance communication and/or the long distance communication. The short distance communication may include Bluetooth®, radio frequency identification (RFID), infrared data association (IrDA), ultra-wideband (UWB), ZigBee, and wireless fidelity (Wi-Fi) technologies, and the long distance communication may include code division multiple access (CDMA), frequency division multiple access (FDMA), time division multiple access (TDMA), orthogonal frequency division multiple access (OFDMA), and single carrier frequency division multiple access (operation SC-FDMA).

The network 400 may include a connection of network elements such as a hub, a bridge, a router, a switch, and a gateway. The network 400 may include one or more connected networks, for example, a multi-network environment, including a public network such as an Internet and a private network such as a safe corporate private network. Access to the network 400 may be provided through one or more wire-based or wireless access networks. Further, the network 400 may support 5G communications and/or an Internet of things (IoT) network for exchanging and processing information between distributed components such as objects.

FIG. 2 is a block diagram of a robot according to an embodiment of the present disclosure.

The robot 100 may be implemented as a fixed device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set top box (operation STB), a DMB receiver, a radio, a washer, a refrigerator, a digital signage, a robot, or a vehicle.

The robot 100 may include a transceiver 110, an input interface 120, a learning processor 130, a sensor 140, an output interface 150, a memory 160, a processor 170, and the like.

The transceiver 110 may transmit/receive data with external devices such as other AI devices or the server 300 by using wired or wireless communication technology. For example, the transceiver 110 may transmit or receive sensor data, user input, a learning model, a control signal, and the like with the external devices.

In this case, the communications technology used by the transceiver 110 may be technology such as global system for mobile communication (GSM), code division multi access (CDMA), long term evolution (LTE), 5G, wireless LAN (WLAN), Wireless-Fidelity (Wi-Fi), Bluetooth™, radio frequency identification (RFID), infrared data association (IrDA), ZigBee, and near field communication (NFC).

The transceiver 110 may receive task information under the control of the processor 170. For example, the transceiver 110 may receive task information on a task of driving to a destination under the control of the processor 170.

The input interface 120 may obtain various types of data.

The input interface 120 may include a camera for inputting an image signal, a microphone for receiving an audio signal, and a user input interface for receiving information inputted from a user. Here, the signal obtained from a camera or a microphone may also be referred to as sensing data or sensor information by regarding the camera or the microphone as a sensor.

The input interface 120 may acquire various kinds of data, such as learning data for model learning and input data used when an output is obtained using a trained model. The input interface 120 may obtain raw input data. In this case, the processor 170 or the learning processor 130 may extract an input feature by preprocessing the input data.

The learning processor 130 may allow a model, composed of an artificial neural network to be trained using learning data. Here, the trained artificial neural network may be referred to as a trained model. The trained model may be used to infer a result value with respect to new input data rather than learning data, and the inferred value may be used as a basis for a determination of an operation to be performed. For example, the learning model may be mounted in the server 300 or mounted in the robot 100, and used to determine a congestion level of the route section.

At this time, the learning processor 130 may perform AI processing together with a learning processor 330 of the server 300.

At this time, the learning processor 130 may include a memory integrated with or implemented in the robot 100. Alternatively, the learning processor 130 may also be implemented by using a memory 160, an external memory directly coupled to the robot 100, or a memory held in an external device.

The sensor 140 may obtain at least one of internal information of the robot 100, surrounding environment information of the robot 100, or user information by using various sensors.

The sensor 140 may include a proximity sensor, an illumination sensor, an acceleration sensor, a magnetic sensor, a gyroscope sensor, an inertial sensor, an RGB sensor, an infrared (IR) sensor, a finger scan sensor, an ultrasonic sensor, an optical sensor, a microphone, a light detection and ranging (lidar) sensor, radar, or a combination thereof.

The sensor 140 may acquire various kinds of data, such as learning data for model learning and input data used when an output is obtained using a trained model. The sensor 140 may obtain raw input data. In this case, the processor 170 or the learning processor 130 may extract an input feature by preprocessing the input data.

The output interface 150 may generate a visual, auditory, or tactile related output.

The output interface 150 may include a display outputting visual information, a speaker outputting auditory information, and a haptic module outputting tactile information.

The memory 160 may store data supporting various functions of the robot 100. For example, the memory 160 may store input data obtained by the input interface 120, sensor information obtained by the sensor 140, learning data, a learning model, a learning history, and the like.

The memory 160 may store map data. The memory 160 may store task information, departure and destination information, route information, a plurality of route section information, and a plurality of subtask information. The memory 160 may store a difficulty level of a subtask. The memory 160 may store performance history information of the subtask. For example, the memory 160 may store a driving difficulty level and a time delay level of a subtask of the robot 100 in the past. The memory 160 may store applicant information including reliability and assistance history information of the applicant.

The memory 160 may include, but is not limited to, magnetic storage media or flash storage media. This memory 160 may include an internal memory and/or an external memory and may include a volatile memory such as a DRAM, a SRAM or a SDRAM, and a non-volatile memory such as one time programmable ROM (OTPROM), a PROM, an EPROM, an EEPROM, a mask ROM, a flash ROM, a NAND flash memory or a NOR flash memory, a flash drive such as an SSD, a compact flash (CF) card, an SD card, a Micro-SD card, a Mini-SD card, an XD card or memory stick, or a storage device such as a HDD.

The processor 170 is a type of a central processor which may drive control software provided in the memory 170 to control an overall operation of the robot 100. The processor 170 may include all kinds of devices capable of processing data. Here, the processor 170 may, for example, refer to a data processing device embedded in hardware, which has a physically structured circuitry to perform a function represented by codes or instructions contained in a program. As examples of the data processing device embedded in hardware, a microprocessor, a central processor (CPU), a processor core, a multiprocessor, an application-specific integrated circuit (ASIC), a field programmable gate array (FPGA), and the like may be included, but the scope of the present disclosure is not limited thereto. The processor 170 may include one or more processors.

The processor 170 may determine at least one executable operation of the robot 100, based on information determined or generated using a data analysis algorithm or a machine learning algorithm. In addition, the processor 170 may control components of the robot 100 to perform the determined operation.

To this end, the processor 170 may request, retrieve, receive, or use data of the learning processor 130 or the memory 160, and may control components of the robot 100 to execute a predicted operation or an operation determined to be preferable of the at least one executable operation.

At this time, if the connection of the external device is required to perform the determined operation, the processor 170 may generate a control signal for controlling the corresponding external device, and transmit the generated control signal to the corresponding external device.

The processor 170 may obtain intent information regarding a user input, and may determine a requirement of a user based on the obtained intent information.

The processor 170 may obtain the intent information corresponding to a user input by using at least one of a speech to text (STT) engine for converting a speech input into a character string or a natural language processing (NLP) engine for obtaining intent information of natural language.

In an embodiment, the at least one of the STT engine or the NLP engine may be composed of artificial neural networks, some of which are trained according to a machine learning algorithm. In addition, the at least one of the STT engine or the NLP engine may be trained by the learning processor 130, trained by a learning processor 330 of an server 300, or trained by distributed processing thereof.

The processor 170 may collect history information including, for example, operation contents and user feedback on an operation of the robot 100, and store the history information in the memory 160 or the learning processor 130, or may transmit the history information to an external device such as a server 300. The collected history information may be used to update a learning model.

The processor 170 may control at least some of components of the robot 100 to drive an application stored in the memory 160. Furthermore, the processor 170 may operate two or more components included in the robot 100 in combination with each other to drive the application.

The processor 170 may be configured to generate route information to a destination based on the map data stored in the memory 160. The processor 170 may be set to generate a plurality of subtasks according to a plurality of route sections included in the route information, determine the difficulty level of a subtask of the plurality of subtasks, and determine an operator to assist in performance of the subtask according to the difficulty level of the subtask. The processor 170 may be configured to recruit applicants for the subtask, and to select an operator from among the applicants based on the reliability of the applicants.

The processor 170 may be configured to determine the congestion level of the route section by using the learning model based on the artificial neural network stored in the memory 160.

The processor 170 may be configured to control the robot according to a control command of the operator.

The processor 170 may be configured to determine the operator's reliability based on a subtask performance result of the operator. The processor 170 may be configured to provide a reward according to the subtask performance result of the operator.

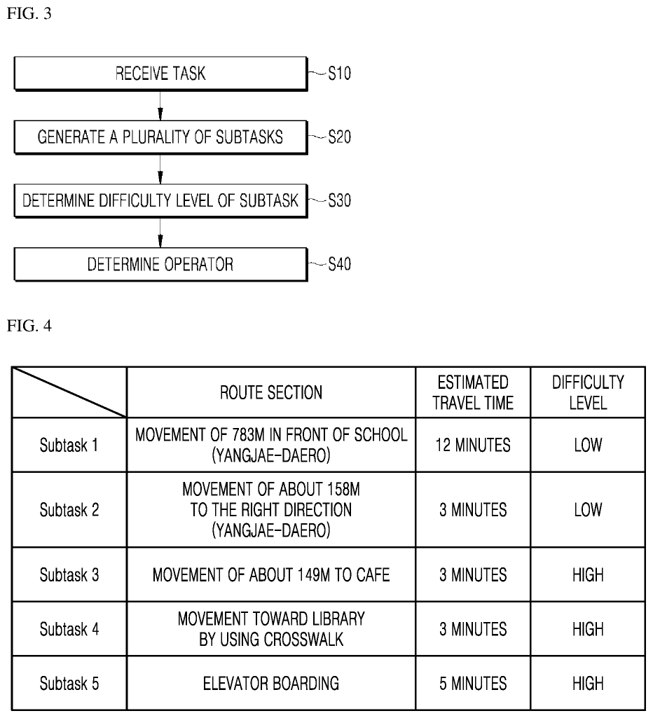

FIG. 3 is a flowchart of a robot control method according to an embodiment of the present disclosure.

A robot control method may include receiving a destination of a driving task (operation S10), generating a plurality of subtasks according to a plurality of route sections included in route information from a current position to a destination (operation S20), determining the difficulty level of a subtask of the plurality of subtasks (operation S30), and determining an operator to assist in the performance of the subtask according to the difficulty level of the subtask (operation S40). Here, the determining the operator (operation S40) may include recruiting applicants for the subtask and selecting an operator from among the applicants based on the reliability of the applicants.

In the operation S10, the robot 100 may receive a destination of a driving task.

The robot 100 may receive task information from the terminal 200 or the server 300 through the transceiver 110 under the control of the processor 170. The robot 100 may directly receive the task information from the user through a user interface screen of the display of the output interface 150.

The task information refers to information necessary for performing the task. For example, the driving task may include departure and destination information.

In the operation S10, the robot 100 may receive the destination of the driving task through the transceiver 110 or through the display under the control of the processor 170. For example, the destination information may include position data such as address information and coordinate information on the map of the destination.

In the operation S20, the robot 100 may generate a plurality of subtasks according to a plurality of route sections included in the route information from the current position to the destination received in the operation S10. The operation S20 may include obtaining a plurality of route sections from the route information generated based on the map data, and generating a plurality of subtasks corresponding to the obtained plurality of route sections.

In the operation S20, the robot 100 may obtain a plurality of route sections from the route information from the current position to the destination based on the map data stored in the memory 160 under the control of the processor 170. The route information includes a plurality of pieces of route section information as a result of searching for the route from the departure to the destination by using the given map data. The route section information may include information on the driving direction and distance, signs, landmarks, and an estimated travel time of each route section.

In the operation S20, the robot 100 may generate a plurality of subtasks corresponding to the plurality of route sections obtained under the control of the processor 170. For example, the robot 100 may generate each subtask in one-to-one correspondence from each route section in order. As one portion of the overall task of driving the entire route from the departure point to the destination, each subtask is a task that performs one route section of the entire route. For example, when the plurality of subtasks generated in the operation S20 are completed, the driving of the entire route may be completed.

As an example, the robot 100 may determine whether the route section according to the route information requires another moving means, and add a dummy subtask for the corresponding route section when another moving means is required. Other moving means may include, for example, an elevator, a moving walk, and an escalator. For example, the robot 100 may parse address information of the destination and add the dummy subtask for boarding the moving means if the destination is not the ground floor or is higher than the ground floor.

In the operation S30, the robot 100 may determine the difficulty level of a subtask of the plurality of subtasks. The robot 100 may perform the operation S30 in real time during the driving under the control of the processor 170. For example, the robot 100 may determine the difficulty level of the corresponding subtask during the driving of the route section corresponding to the subtask.

The difficulty level of the subtask refers to the degree to which it is difficult for the robot 100 to complete the subtask by itself. The higher the difficulty level, the more difficult it is for the robot 100 to complete the subtask by itself. For example, the difficulty level of the driving subtask may be inversely proportional to the probability that the robot 100 will be able drive the route section corresponding to the driving subtask in the autonomous driving mode.

The difficulty level of the subtask is determined based on the driving difficulty level, the time delay level, or the driving difficulty level and the time delay level.

First, a process of determining the difficulty level of the subtask based on the driving difficulty level will be described.

The operation S30 may include determining the congestion level of the route section corresponding to the subtask, determining the driving difficulty level of the subtask based on the congestion level, and determining the difficulty level of the subtask based on the driving difficulty level.

The robot 100 determines the congestion level of the route section corresponding to the subtask in order to determine the difficulty level of the subtask.

The congestion level may be determined based on obstacle information detected in the driving direction. Here, an obstacle refers to a driving obstacle that exists in the driving direction. For example, obstacles may include people, cars, objects, road fixtures, and other robots 100. The obstacle information includes information such as information on the number of obstacles, the distance to the obstacles, the moving speed and the moving direction of the obstacles. For example, the congestion level increases as the number of obstacles increases, as the distance to the obstacle is closer, as the moving speed increases, and as the difference between the moving direction and the driving direction increases.

The robot 100 may obtain the obstacle information based on a driving direction image captured by using the camera of the input interface 120 or the sensor 140 under the control of the processor 170. The robot 100 may obtain the obstacle information by controlling a sensor of the sensor 140, for example, an IR sensor, an ultrasonic sensor, and a proximity sensor, under the control of the processor 170.

As an example, the robot 100 may obtain the obstacle information in the driving direction and determine the congestion level of the route section by using an object recognition model based on the artificial neural network stored in the memory 160 under the control of the processor 170.

The robot 100 determines the driving difficulty level of the subtask based on the congestion level of the route section corresponding to the subtask.

The driving difficulty level may be determined, for example, by a value of the congestion level. For example, the driving difficulty level may be determined by weighting the congestion level by a weight determined according to driving environment factors such as the inclination of the route section and weather information affecting a pavement state and a road surface state.

Subsequently, the robot 100 may determine the difficulty level of the corresponding subtask based on the driving difficulty level of the subtask. To this end, the robot 100 may consider the driving capability of the robot 100. The driving capability of the robot 100 may be determined according to an obstacle avoidance capability and a current state of the robot 100.

For example, the robot 100 may apply a weight to the driving difficulty level according to the driving capability of the robot 100 under the control of the processor 170. For example, the driving difficulty level determined above may be weighted by a weight determined according to the driving capability of the robot 100. For example, when the driving capability of the robot 100 is low, the weight may be determined as a value greater than one.

For example, the robot 100 may determine the difficulty level of the subtask by comparing the driving difficulty level of the subtask with a reference difficulty level. The reference difficulty level is a predetermined threshold, which may be a fixed value or determined based on the driving capability of the robot 100.

As an example, the difficulty level of the subtask may be classified into, for example, level 1 to level N (where N is a natural number) or high, medium, and low or high and low. For example, when the driving difficulty level of the subtask is higher than the reference difficulty level, the robot 100 may determine the difficulty level of the corresponding subtask as ‘high,’ and when the driving difficulty level of the subtask is equal to or less than the reference difficulty level, the robot 100 may determine the difficulty level of the corresponding subtask as ‘low’, under the control of the processor 170.

As an example, the robot 100 may store the obstacle information that was obtained for determining the congestion level in the memory 160 in the operation S20 under the control of the processor 170. The robot 100 may collect the obtained obstacle information together with the obtained time information and place information, and provide the collected information to the learning model stored in the memory 160 and/or a learning model 331a stored in the memory 330 of the server 300 as input data under the control of the processor 170.

The robot 100 may determine the congestion level of the route section under the control of the processor 170 by using the learning model stored in the memory 160 or the memory 330 of the server 300. For example, the robot 100 may determine the congestion level of the route section by using the learning model based on the artificial neural network. In this case, the robot 100 may perform the operation S30 together with the operation S20. That is, the robot 100 may determine the congestion level of the plurality of route sections by using the learning model in the operation S20 of generating the plurality of subtasks. The robot 100 may determine the driving difficulty level based on the congestion level determined by using the learning model, and determine the difficulty level of the plurality of subtasks before the start of the driving in the operation S20.

A process of determining the difficulty level of the subtask based on the time delay level will be described.

The operation S30 may include obtaining an estimated travel time and an actual travel time of the subtask, determining the time delay level of the subtask based on the obtained estimated travel time and actual travel time, and determining the difficulty level of the subtask based on the determined time delay level.

The robot 100 may obtain the estimated travel time and the actual travel time of the subtask in order to determine the difficulty level of the subtask. The robot 100 may obtain the actual travel time based on a start time and a current time of the subtask under the control of the processor 170. The estimated travel time of the subtask may be obtained from each piece of the route section information in the operation S20.

The robot 100 may determine the time delay level of the subtask based on the estimated travel time and the actual travel time under the control of the processor 170 in order to determine the difficulty level of the subtask. For example, the time delay level refers to a delay rate determined by the ratio between the estimated travel time and the actual travel time.

The robot 100 may determine the difficulty level of the subtask based on the determined time delay level. To this end, the robot 100 may consider the driving capability of the robot 100. The driving capability of the robot 100 may be determined according to the obstacle avoidance capability and the current state of the robot 100.

The robot 100 may apply a weight to the time delay level according to the driving capability of the robot 100 under the control of the processor 170. In this case, the previously determined time delay level may be weighted by a weight determined according to the driving capability of the robot 100. For example, if the driving capability of the robot 100 is low, the weight may be determined as a value smaller than one.

The robot 100 may determine the difficulty level of the subtask by comparing the time delay level of the subtask with a reference delay level. The reference delay level is a predetermined threshold, which may be a fixed value or determined based on the driving capability of the robot 100.

As an example, the difficulty level of the subtask may be classified into, for example, level 1 to level N (where N is a natural number) or high, medium, and low or high and low. For example, when the time delay level of the subtask is higher than the reference delay level, the robot 100 may determine the difficulty level of the corresponding subtask as ‘high,’ and when the time delay level of the subtask is equal to or less than the reference delay level, the robot 100 may determine the difficulty level of the corresponding subtask as ‘low’, under the control of the processor 170.

As an alternative example of determining the difficulty level of the subtask based on the time delay level, the robot 100 may determine the difficulty level of the corresponding subtask as ‘high’ when the actual travel time of the subtask exceeds the estimated travel time. Here, the fact that the difficulty level of the subtask is ‘high’ may mean that the robot 100 may be unable to complete the corresponding subtask only by autonomous driving.

In the operation S40, the robot 100 may determine an operator to assist in performance of the subtask according to the difficulty level of the subtask determined in the operation S30 under the control of the processor 170.

The operation S40 may include recruiting applicants for the subtask and selecting an operator from among the applicants based on the reliability of the applicants.

In the operation S40, the robot 100 may recruit applicants for the subtask.

First, the robot 100 may compare the difficulty level determined in the operation S30 with a reference value, and determine whether to recruit applicants for the subtask according to the comparison result under the control of the processor 170. The reference value is a predetermined threshold, which may be a fixed value or determined based on the driving capability of the robot 100. The robot 100 may determine that the recruitment of applicants is necessary when the difficulty level determined in the operation S30 is higher than the reference value.

When it is determined that the recruitment of applicants is necessary, the robot 100 may transmit an applicant recruitment message to all registered users. Here, the recruitment message may include, for example, current position information of the robot 100, the route section information, difficulty level, and elapsed time information of the corresponding subtask.

The registered user is a user who has subscribed to a robot support service, and may communicate with the robot 100 and the server 300 through a robot support application installed in the user's terminal 200. The robot support application installed in the user's terminal 200 may provide a function of remotely controlling the robot 100.

For example, the robot 100 may transmit a recruitment request to the server 300 through the transceiver 110 under the control of the processor 170, and the server 300 may transmit the applicant recruitment message to the terminal 200 of all registered users. For example, the robot 100 may directly transmit the applicant recruitment message to the terminal 200 of all registered users through the transceiver 110 under the control of the processor 170.

The user who wants to apply to assist in performing the subtask may respond to the applicant recruitment through the terminal 200. For example, the user may apply by using the application installed in the terminal 200. The user who has transmitted the applicant application becomes an applicant for the corresponding subtask. The robot 100 may receive the applicant application transmitted by the applicant through the transceiver 110 under the control of the processor 170. For example, the robot 100 may receive the applicant application from the terminal 200 or the server 300 through the transceiver 110.

In the operation S40, the robot 100 may select an operator from among the applicants based on the reliability of the applicants. In the operation S40, the robot 100 may select, for example, an applicant having the highest reliability among the applicants as an operator. In the operation S40, the robot 100 may select an operator from among the applicants based on, for example, assistance history information of the applicant.

The reliability is an indicator of the task performance capability of the applicant, and may be determined and updated based on the performance result of the subtask from each time the applicant has performed the subtask as an operator. The reliability determination will be described later with reference to FIG. 8.

Additionally, the robot control method may further include driving according to a control command of the operator.

In order to perform the driving according to the control command of the operator, the robot 100 may grant an operation right for remote control of the robot 100 to the applicant who has been selected as the operator. The robot 100 may request the operator to undergo an authentication process by means of the robot 100, the server 300, or a separate authentication server, before granting the operation right to the operator. The operator may provide his or her qualification/capability of remotely controlling the robot 100, and membership information and/or identity information of the robot control application, to the robot 100, the server 300, or the separate authentication server by using the terminal 200. The robot 100, the server 300, or the authentication server may authenticate the provided information.

In order to perform the driving according to the control command of the operator, the robot 100 may receive the control command of the operator, and transmit the operation state of the robot 100 according to the control command to the terminal 200 of the operator.

As an example, the robot 100 may communicate with the terminal 200 of the operator through a security channel. For example, the robot 100 may control the processor 170 so as to connect the terminal 200 of the operator with the security channel through the transceiver 110, receive the control command of the operator by using the security channel, and transmit the operation state of the robot 100 according to the control command to the terminal 200 of the operator.

The driving according to the control command of the operator may include the robot 100 transmitting the current state information of the robot 100 to the operator through the transceiver 110 and receiving the control command generated based on the current state information, under the control of the processor 170.

Here, the robot 100 may transmit the current state information to the server 300 through the transceiver 110, and the server 300 may transmit the current state information of the robot 100 to the terminal 200 of the operator. The robot 100 may receive the control command transmitted from the terminal 200 to the server 300. In another example, the robot 100 may directly communicate with the terminal 200.

The robot 100 may transmit the current state information of the robot 100 to the operator through the transceiver 110 under the control of the processor 170.

The current state information may include current position information of the robot 100, subtask information on a subtask currently being performed or to be performed, and the route section information, difficulty level information, elapsed time information, and time delay level corresponding to the subtask.

The current state information may include input data obtained by the input interface 120 of the robot 100 and sensor information sensed by the sensor 140. For example, the current state information may include a driving direction image, a surrounding image, and an image of the robot 100 itself, which have been captured by the camera. Here, the meaning of “image” is inclusive of a still image and a moving image. Further, the current state information may include information such as surrounding sound information obtained by the microphone, speed information of the robot 100 obtained by a speed sensor, and posture information of the robot 100 estimated by using an inertial sensor or the like.

The current state information may include motion monitoring information of the robot 100. For example, the current state information may include the current operation mode, operation log information, error information, and the like of the robot 100.

The robot 100 may receive the control command generated based on the current state information of the robot 100 from the operator through the transceiver 110 under the control of the processor 170. The operator may transmit to the robot 100, through the server 300 or directly, a control command necessary for completing the subtask of the robot 100 based on the current state information of the robot 100 received through the terminal 200. For example, the control command may be a wait command causing the robot 100 to wait at a designated place, or a return command causing the robot 100 to return to a designated place. For example, the control command may be a command for semi-autonomous driving. For further example, the control command may be a control command for controlling a driving direction and a driving speed for avoiding an obstacle.

Additionally, the driving according to the control command of the operator may include checking whether the driving according to the control command of the operator is safe, and determining whether to drive according to the control command of the operator according to the checked result.

The robot 100 may check whether the driving according to the control command of the operator is safe. As an example, the robot 100 may adopt a design that complies with ISO13482 for safety requirements.

The robot 100 may check whether the driving according to the control command is safe before performing the control command of the operator. For example, when the speed instructed by the control command is out of the safe driving speed range of the robot 100, the robot 100 may determine that the driving according to the control command is not safe.

The robot 100 may check whether the driving according to the control command is safe while performing the control command of the operator. For example, the robot 100 may monitor the current state information of the robot 100 through the input interface 120 and/or the sensor 140 under the control of the processor 170, and determine that the driving according to the control command is not safe upon sensing an abnormal state as the monitoring result. Here, the abnormal state may include, for example, detection of a cliff, a sensor abnormality, a kidnap, a subsystem down, a severe shock, and an attempt to destroy the robot 100.

The robot 100 may determine whether to drive according to the control command of the operator according to the result of the safety check. For example, when the driving according to the control command of the operator is likely to cause a safety problem, the robot 100 may stop its operation under the control of the processor 170. In this case, the robot 100 may transmit an emergency message to the server 300 through the transceiver 110 under the control of the processor 170. The robot 100 may maintain the stopped state until the safety problem is solved or until an instruction is received from the server 300.

FIG. 4 is a table illustrating subtask information for performing an exemplary task.

For example, assume the task of returning a book received from a user at school to the reference library positioned on the fourth floor of the library.

The robot 100 may receive the task information in the operation S10 of FIG. 3. The task information may include departure information, destination information, and mission information. For example, the robot 100 may receive a task in which the departure point is a school, the destination is the reference library on the fourth floor of the library, and the mission is to return a book.

In the operation S20, the robot 100 may generate a plurality of subtasks. That is, the robot 100 may obtain route information from the departure point (the school) to the destination (the fourth floor of the library) based on the map data stored in the memory 160 under the control of the processor 170. Here, the route information includes a plurality of pieces of route section information and the estimated travel time information of each route section.

The robot 100 may obtain a plurality of route sections from the obtained route information. The example illustrated has been divided into five route sections.

The robot 100 may generate a subtask corresponding to each route section under the control of the processor 170. For example, the robot 100 may obtain a subtask 1 (route section 1, movement of 783 m in front of the school, 12 minutes), a subtask 2 (route section 2, movement of about 158 m to the right direction, 3 minutes), a subtask 3 (route section 3, movement of about 149 m to the cafe, 3 minutes), and a subtask 4 (route section 4, movement toward the library by using a crosswalk, 3 minutes). Further, the robot 100 may add a subtask 5 (route section 5, elevator boarding, 5 minutes) as a dummy subtask because the destination is not the ground floor.

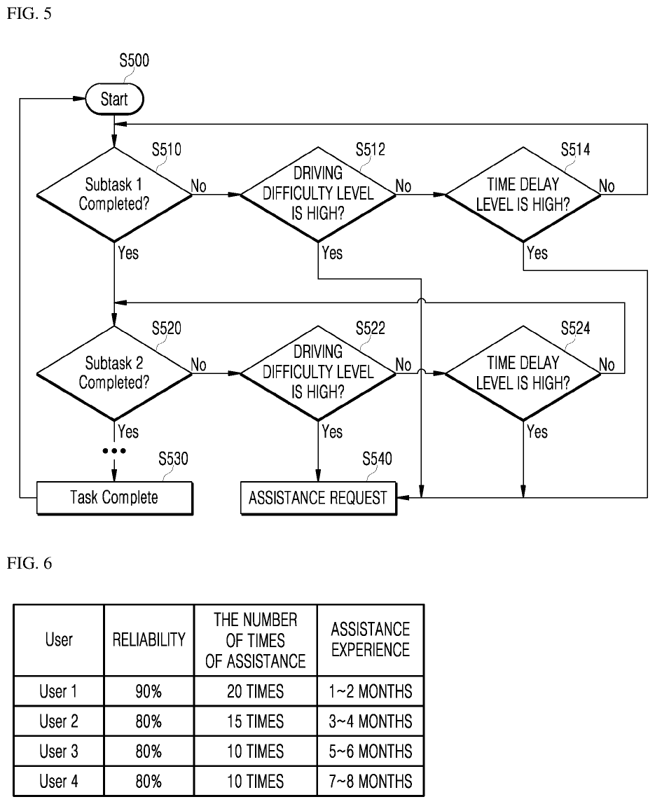

In the operation S30, the robot 100 may determine difficulty levels of the subtasks 1 to 5 according to the above-described determination process of the difficulty level of the subtask under the control of the processor 170. Although in the table of FIG. 4 the difficulty level has been determined as one of “high” or “low” for exemplary purposes, the difficulty level is not limited thereto. Hereinafter, the processes of the operations S30 and S40 will be exemplarily described with reference to FIG. 5.

FIG. 5 is a flowchart of a robot control method according to an embodiment of the present disclosure.

In operation S500, the robot 100 starts to perform a first subtask among the plurality of subtasks generated in the operation S20. For example, the robot 100 starts autonomous driving according to the route section 1 in the operation S500.

In operation S510, the robot 100 may determine whether the first subtask has been completed under the control of the processor 170. That is, the robot 100 may determine whether it has reached the end point of the route section 1 based on its current position.

In the operation S510, when the first subtask is not yet completed, that is, when the first subtask is in progress, the method proceeds to operation S512.

In the operation S512, the robot 100 determines the driving difficulty level of the first subtask under the control of the processor 170. For example, the robot 100 performs the determination process of the driving difficulty level described above with reference to the operation S30.

In the operation S512, the robot 100 compares the driving difficulty level of the first subtask with a reference value, and proceeds to operation S540 to recruit the applicant to assist in the performance of the first subtask when the driving difficulty level of the first subtask is more difficult than the reference value as the comparison result under the control of the processor 170. The operation S540 corresponds to the operation S40 described above with reference to FIG. 3. In the example of FIG. 4, since the driving difficulty level of the first subtask is lower than the reference value and is “low,” the method proceeds to operation S514.

In the operation S514, the robot 100 determines the time delay level of the first subtask under the control of the processor 170. For example, the robot 100 performs the determination process of the time delay level described above with reference to the operation S30.

In the operation S514, the robot 100 compares the time delay level of the first subtask and the reference value, and proceeds to the operation S540 to recruit the applicant to assist in the performance of the first subtask when the time delay level of the first subtask is more difficult than the reference value as the comparison result under the control of the processor 170. The operation S540 corresponds to the operation S40 described above with reference to FIG. 3. When the time delay level of the first subtask is “low” the method returns to the operation S510.

In the operation S510, when the first subtask has been completed, the method proceeds to operation S520 to start a second subtask.

In the operation S520, when the second subtask has not yet been completed, that is, when the second subtask is in progress, the method proceeds to operation S522.

In the operation S522, the robot 100 determines the driving difficulty level of the second subtask under the control of the processor 170. For example, the robot 100 performs the determination process of the driving difficulty level described above with reference to the operation S30.

In the operation S522, the robot 100 compares the driving difficulty level of the second subtask with the reference value, and proceeds to the operation S540 to recruit the applicant to assist in the performance of the second subtask when the driving difficulty level of the second subtask is more difficult than the reference value as the comparison result under the control of the processor 170. The operation S540 corresponds to the operation S40 described above with reference to FIG. 3. In the example of FIG. 4, since the driving difficulty level of the second subtask is lower than the reference value and is “low,” the method proceeds to operation S524.

In the operation S524, the robot 100 determines the time delay level of the second subtask under the control of the processor 170. For example, the robot 100 performs the determination process of the time delay level described above with reference to the operation S30.

In the operation S524, the robot 100 compares the time delay level of the first subtask and the reference value, and proceeds to the operation S540 to recruit the applicant to assist in the performance of the second subtask when the time delay level of the first subtask is delayed further than the reference value as the comparison result under the control of the processor 170. When the time delay level of the second subtask is “low,” the method returns to the operation S520.

In the operation S520, when the second subtask has been completed, the task may also be performed through the same process for the remaining tasks.

In the operation S530, when the task has been completed, that is, when the destination is reached, the robot 100 returns to the operation S500 to wait until the next task is received.

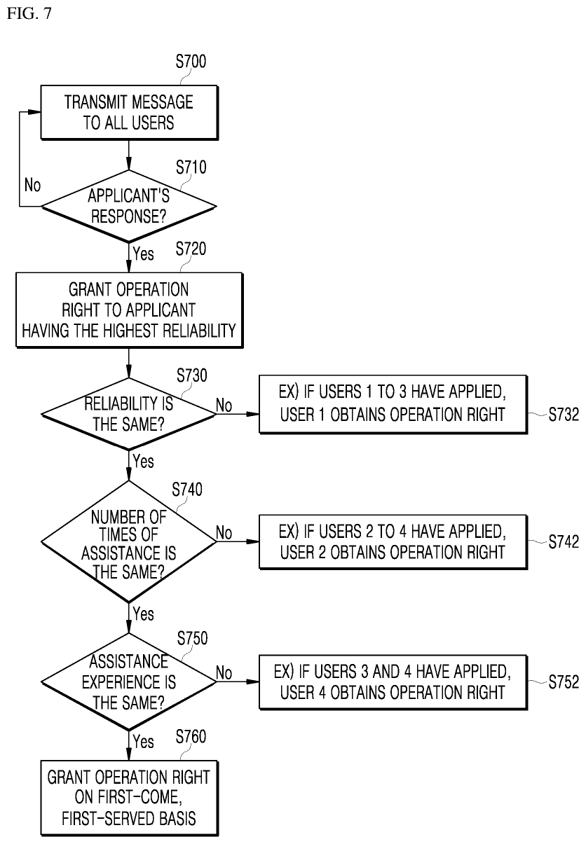

Hereinafter, a process of determining an operator of the operation S40 will be described in detail with reference to FIGS. 6 and 7.

FIG. 6 is a table illustrating exemplary applicant information.

Referring to FIG. 3, in the operation S40, the robot 100 may recruit applicants to assist in performance of the subtask. For example, in FIG. 6, the applicant information includes the reliability and the assistance history information of the applicant. The assistance history information includes the number of times of assistance and the assistance experience of the applicant. Here, the number of times of assistance means the number of times that the applicant has successfully completed the subtask.

For example, the reliability of a first applicant is 90%, the number of times of assistance is 20 times, and the assistance experience is 1 to 2 months. For example, the reliability of a third applicant is 80%, the number of times of assistance is 10 times, and the assistance experience is 5 to 6 months. Hereinafter, the operator determination process in FIG. 7 will be described with reference to the exemplary table in FIG. 6.

FIG. 7 is a flowchart of an operator determination process according to an embodiment of the present disclosure.

The robot 100 determines the operator to assist in performance of the subtask in the operation S40 according to the difficulty level of the subtask determined in the operation S30. Operations S700 to S760 in FIG. 7 may be performed in the operation S40. The operation S700 in FIG. 7 may correspond to the operation S540 of FIG. 5.

In operation S700, the robot 100 may transmit the applicant recruitment message to all registered users under the control of the processor 170, as described above with reference to the operation S40.

In operation S710, the robot 100 may wait for the applicant's response. When the applicant's response is not received in the operation S710, the operation S700 may be repeated.

In the operation S710, when the applicant's response is received, the method proceeds to operation S720.

In the operation S720, the robot 100 may select, as an operator, the applicant having the highest reliability among the applicants that have responded in the operation S710 under the control of the processor 170. In the operation S710, when all of the first to fourth applicants have responded, for example, with reference to FIG. 6, the robot 100 may select the first applicant, who has the highest reliability, as the operator in the operation S720. The operation right of the robot 100 is granted to the applicant selected as the operator.

In operation S730, the robot 100 may compare the reliability of the applicants who have responded in the operation S710 under the control of the processor 170. When the reliability of the responding applicants is different, the applicant having the highest reliability is selected as the operator. If the first to third applicants have responded with reference to FIG. 6, the robot 100 may select the first applicant, who has the highest reliability, as the operator in operation S732. When the reliability of the responding applicants is the same, the method proceeds to operation S740.

In the operation S740, the robot 100 may compare the number of times of assistance of the applicants who have responded in the operation S710 under the control of the processor 170. When the number of times of assistance of the responding applicants is different, the applicant having the largest number of times of assistance is selected as the operator. If the second to fourth applicants have responded with reference to FIG. 6, the robot 100 may select the second applicant, who has the largest number of times of assistance, as the operator in operation S742. When the number of times of assistance of the responding applicant is the same, the method proceeds to operation S750.

In the operation S750, the robot 100 may compare the assistance experience of the applicants who have responded in the operation S710 under the control of the processor 170. When the assistance experience of the responding applicants is different, the applicant having the most assistance experience is selected as an operator. If the third applicant and the fourth applicant have responded with reference to FIG. 6, the robot 100 may select the fourth applicant, who has more assistance experience, as the operator in the operation S752. When the assistance experience of the responding applicant is the same, the method proceeds to operation S760.

In the operation S760, the robot 100 may determine the operator on a first-come, first-served basis. For example, the robot 100 may determine, as the operator, the applicant who responded first in the operation S710 under the control of the processor 170. The operator may be a teleoperator that operates the robot 100 remotely.

The operations S720, S730, S740, S750, and S760 are exemplary operations, and the order of the operations may be changed and some operations may also be omitted. For example, the operation S740 and/or the operation S750 may be reversed in order or omitted.

FIG. 8 is a flowchart of a reliability determination process according to an embodiment of the present disclosure.

The robot control method described above with reference to FIG. 3 may further include determining an operator's reliability based on a subtask performance result of the operator. FIG. 8 illustrates a process of determining the operator's reliability.

The operator determined in the operation S40 with reference to FIG. 3 starts remote control of the robot 100 in operation S800, and performs a subtask.

In operation S810, when the operator does not successfully complete the subtask, the robot 100 may reduce the operator's reliability under the control of the processor 170 in operation S812. For example, the reliability is reduced according to the following Equation 1.

Reliability=(number of times of successful subtask performance−1)/total number of subtask assistance times Equation 1:

In the operation S810, when the operator has completed the subtask, the robot 100 may increase the operator's reliability in operation S822 or operation S824. Here, the increasing level of reliability may vary according to whether the operator has completed the subtask within the estimated time.

In operation S820, the robot 100 determines whether the operator has completed the subtask within the estimated time under the control of the processor 170.

In the operation S820, when the operator has not completed the subtask in the estimated time, the operator's reliability may increase according to the following Equation 2 in operation S822.

Reliability=number of times of successful subtask performance/total number of subtask assistance times Equation 2:

In the operation S820, when the operator has completed the subtask in the estimated time, the operator's reliability may increase according to the following Equation 3 in operation S824.

Reliability=(number of times of successful subtask performance+x)/(total number of subtask assistance times+x), where x=actual travel time/estimated travel time Equation 3:

The operations S810 to S824 are exemplary, and the operation S820 may be omitted. For example, in the operation S810, when the operator has completed the subtask, the operator's reliability may increase according to Equation 2 or Equation 3.

Additionally, in the operation S810, when the operator has completed the subtask, the robot 100 may provide a reward to the operator in the operation S822 or the operation S824. For example, the robot 100 may provide the reward to the operator according to the performance result of the subtask under the control of the processor 170. For example, the reward may be cyber money, earned points, or credits available through the application installed in the terminal 200.

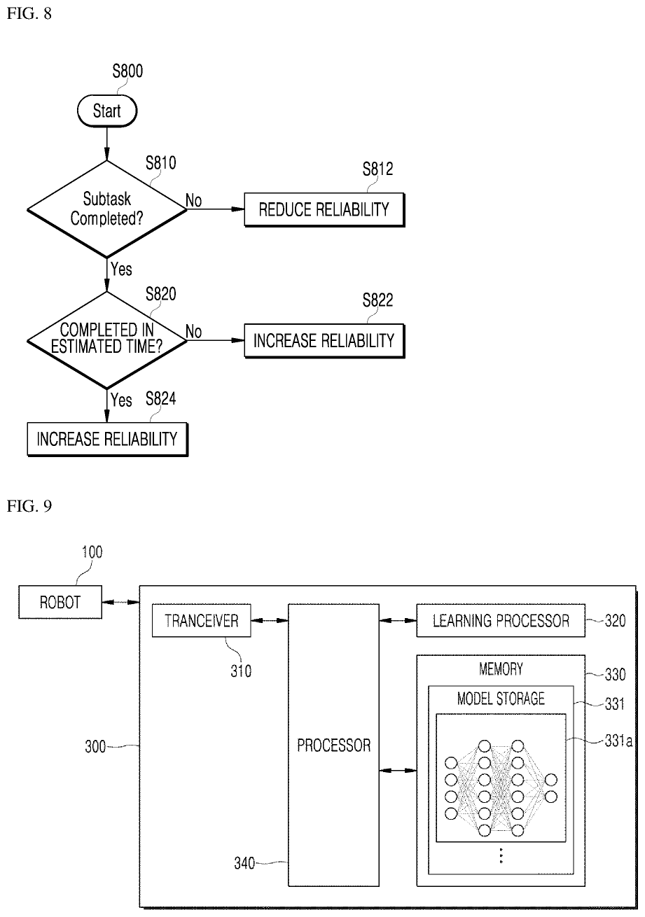

FIG. 9 is a block diagram of a server according to an embodiment of the present disclosure.

The server 300 may mean a control server configured to control the robot 100. The server 300 may be a central control server configured to monitor a plurality of the robots 100. The server 300 may store and manage state information of the robots 100. For example, the state information may include the position information, operation mode, driving route information, past task performance history information, and remaining battery information of the robots 100.

The server 300 may determine a robot 100 to process the task. In this case, the server 300 may consider the state information of the robots 100. For example, the server 300 may determine a robot 100 that is positioned closest to the departure point, or a robot 100 in an idle state returning from the destination, as the robot 100 to process the task. For example, the server 300 may determine the robot 100 to process the task considering the past task performance history information. For example, the server 300 may determine a robot 100 that has successfully performed the route driving according to the task in the past as the robot 100 to process the task.

The server 300 may refer to a device for training an artificial neural network using a machine learning algorithm or using a trained artificial neural network. Here, the server 300 may include a plurality of servers to perform distributed processing, or may be defined as a 5G network. The server 300 may also be included as a configuration of a portion of an AI device, such as the robot 100, to thereby perform at least some of the AI processing together with the AI device.

The server 300 may include a transceiver 310, a memory 330, a learning processor 320, and a processor 340.

The transceiver 310 may transmit/receive data with an external device such as the robot 100.

The memory 330 may include a model storage 331. The model storage 331 may store a model (or an artificial neural network 331a) that is being trained or has been trained via the learning processor 320.

The learning processor 320 may train the artificial neural network 331a using learning data. A learning model may be used while mounted in the server 300 of the artificial neural network, or may be used while mounted in an external device such as the robot 100, or the like. For example, the learning model may be mounted on the server 200 or mounted on the robot 100, and used to determine the congestion level of the route section.

The learning model may be implemented as hardware, software, or a combination of hardware and software. When a portion or the entirety of the learning model is implemented as software, one or more instructions, which constitute the learning model, may be stored in the memory 330.

The processor 340 may infer a result value with respect to new input data by using the learning model, and generate a response or control command based on the inferred result value.

The example embodiments described above may be implemented through computer programs executable through various components on a computer, and such computer programs may be recorded on computer-readable media. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as those produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations may be made depending on design conditions and factors within the scope of the appended claims or equivalents thereof.

It should be apparent to those skilled in the art that various substitutions, changes and modifications which are not exemplified herein but are still within the spirit and scope of the present disclosure may be made.

In the foregoing, while specific embodiments of the present disclosure have been described for illustrative purposes, the scope or spirit of the present disclosure is not limited thereto, it will be understood by those skilled in the art that various changes and modifications may be made to other specific embodiments without departing from the spirit and scope of the present disclosure. Therefore, the scope of the present disclosure should be defined not by the above-described embodiments but by the technical idea defined in the following claims.

What is claimed is:

1. A robot control method, comprising:
receiving task information on a task of driving to a destination;
generating a plurality of subtasks according to a plurality of route sections comprised in route information from a current position to the destination;
determining a difficulty level of a subtask of the plurality of subtask; and
determining an operator to assist in performance of the subtask according to the difficulty level of the subtask,
wherein the determining the operator comprises:
recruiting applicants for the subtask; and
selecting the operator from among the applicants based on reliability of the applicants.

2. The robot control method of claim 1, wherein the generating a plurality of subtasks comprises:
obtaining the plurality of route sections from the route information generated based on map data; and
generating the plurality of subtasks corresponding to the plurality of route sections.

3. The robot control method of claim 1, wherein the determining a difficulty level comprises determining the difficulty level of the subtask in real time during driving.

4. The robot control method of claim 1, wherein the determining a difficulty level comprises:
determining a congestion level of the route section corresponding to the subtask;
determining a driving difficulty level of the subtask based on the congestion level; and
determining the difficulty level based on the driving difficulty level.

5. The robot control method of claim 4, wherein the determining a congestion level comprises determining the congestion level of the route section by using a learning model based on an artificial neural network.

6. The robot control method of claim 1, wherein the determining a difficulty level comprises:
obtaining an estimated travel time and an actual travel time of the subtask;
determining a time delay level of the subtask based on the estimated travel time and the actual travel time; and
determining the difficulty level based on the time delay level.

7. The robot control method of claim 1, wherein the recruiting applicants further comprises:
comparing the difficulty level with a reference value; and
determining whether to recruit applicants for the subtask according to the comparison result.

8. The robot control method of claim 1, wherein the recruiting applicants comprises transmitting an applicant recruit message to all registered users.

9. The robot control method of claim 1, wherein the selecting an operator comprises selecting an applicant having the highest reliability among the applicants as the operator.

10. The robot control method of claim 1, wherein the selecting an operator comprises selecting the operator from among the applicants based on assistance history information of the applicants.

11. The robot control method of claim 1, further comprising driving according to a control command of the operator.

12. The robot control method of claim 11, wherein the driving comprises:
transmitting current state information to the operator; and
receiving the control command generated based on the current state information.

13. The robot control method of claim 11, wherein the driving comprises:
checking whether the driving according to the control command of the operator is safe; and
determining whether to drive according to the control command depending upon the checked result.

14. The robot control method of claim 1, further comprising determining the operator's reliability based on a subtask performance result of the operator.

15. A robot, comprising:
a memory configured to store map data; and
a processor configured to generate route information of a task of driving to a destination based on the map data,
wherein the processor is configured to perform operations of:
generating a plurality of subtasks according to a plurality of route sections comprised in the route information;
determining the difficulty level of a subtask of the plurality of subtasks; and
determining an operator to assist in performance of the subtask according to the difficulty level of the subtask, and
wherein the operation of determining an operator comprises operations of:
recruiting applicants for the subtask; and
selecting the operator from among the applicants based on reliability of the applicants.

16. The robot of claim 15, wherein the processor is further configured to determine the operator's reliability based on a subtask performance result of the operator.

17. The robot of claim 15, wherein the processor is further configured to provide a reward according to the subtask performance result of the operator.

18. The robot of claim 15, wherein the processor is further configured to control the robot according to a control command of the operator.

19. The robot of claim 15, wherein the processor is further configured to determine the difficulty level of the subtask in real time during driving.

20. The robot of claim 15, wherein the processor is further configured to select an applicant having the highest reliability among the applicants as the operator.
